(19) United States
(12) Patent Application Publication
(10) Pub. No.: US 2026/0298793 A1
(43) Pub. Date: Oct. 1, 2026

(54) SOOT DETECTION METHOD FOR MILD COMBUSTION SYSTEM OF TAR-CONTAINING BIOMASS GASIFIED GAS

(71) Applicants: Tianjin University, Tianjin (CN); Tianjin University of Commerce, Tianjin (CN)

(72) Inventors: Beibei YAN, Tianjin (CN); Shengquan ZHOU, Tianjin (CN); Sensen LU, Tianjin (CN); Guanyi CHEN, Tianjin (CN); Xiaochao ZHU, Tianjin (CN); Wenzhu WU, Tianjin (CN); Zhanjun CHENG, Tianjin (CN)

(73) Assignees: Tianjin University, Tianjin (CN); Tianjin University of Commerce, Tianjin (CN)

(21) Appl. No.: 19/212,761

(22) Filed: May 20, 2025

(30) Foreign Application Priority Data
Mar. 26, 2025 (CN) 202510369326.X

(51) Int. Cl. G01N 15/075; F23K 5/10; F23K 5/20; F23K 5/22

(52) U.S. Cl. CPC G01N 15/075; F23K 5/10; F23K 5/20; F23K 5/22; F23K 2300/103; F23K 2300/204; F23K 2300/205

(57) ABSTRACT

A soot detection method for a moderate or intense low oxygen dilution (MILD) combustion system of tar-containing biomass gasified gas includes the following steps: S1. mounting a MILD combustion system of tar-containing biomass gasified gas; S2. mounting a soot detection system; and S3. detecting soot generation process. The fuel supply of tar-containing biomass gasified gas is achieved with a controlled evaporator and mixer to ensure that tar participates in combustion in a gaseous state; and the whole process of soot generation under MILD combustion is detected by combining a thermophoresis sampling system and an optical diagnosis system. The soot detection method not only solves the fuel supply caused by the presence of tar, achieving the MILD combustion of tar-containing biomass gasified gas, but also proposes an effective detection method for the whole process of soot generation under MILD combustion, providing a solution for related experimental research.

### CROSS REFERENCE TO THE RELATED APPLICATIONS

This application is based upon and claims priority to Chinese Patent Application No. 202510369326.X, filed on Mar. 26, 2025, the entire contents of which are incorporated herein by reference.

### TECHNICAL FIELD

The present invention relates to the technical field of renewable low-carbon energy utilization and soot emission control, and specifically to a soot detection method for a moderate or intense low oxygen dilution (MILD) combustion system of tar-containing biomass gasified gas.

### BACKGROUND

In the context of “carbon peaking and carbon neutrality” goals, renewable zero-carbon energy biomass has received widespread attention. Biomass gasification technology can absorb and efficiently utilize biomass waste. The biomass gasified gas (BGG) obtained by gasification can also fill the gas gap, and the importance of the Biomass gasified gas is increasingly remarkable. Affected by gasified raw materials, furnace type and medium, the composition of BGG is very complex. In addition to the combustible components CO, H₂ and a small amount of CₙHₘ, BGG also contains a large amount of non-combustible gas and tar and other impurities. This leads to a series of problems such as difficulty in ignition, low combustion efficiency, unstable flame, and difficulty in controlling the emission of pollutants such as NOₓ and soot under conventional combustion. Moderate or intense low oxygen dilution (MILD) combustion is a combustion method achieved through high-temperature preheating and low-oxygen dilution, which can achieve low peak temperature and high average temperature in the furnace. Therefore, MILD combustion has the advantages of high thermal radiation efficiency and low NOₓ emissions, and has been proven to reduce carbon soot emissions from hydrocarbon fuel combustion. The MILD combustion for BGG has a stable flame and good NOₓ reduction characteristics under all operating conditions.

Existing studies on the MILD combustion for BGG only consider simulated pure BGG and focus on only two pollutants, NOₓ and CO, and the studies on soot emission caused by tar are lacking. The tar condenses into a highly viscous liquid at room temperature, which is prone to adhere to and clog pipelines and other conveying equipment, thus seriously affecting conveying efficiency. Meanwhile, tar often participates in the combustion reaction in gaseous form during actual combustion. Currently, there is a lack of a fuel supply and conveying method for tar-containing biomass gasified gas, which mixes tar (or model compounds) at different concentrations with gasified gas in a gaseous state for application in MILD combustion experiments or pilot studies. In addition, the MILD combustion method has different temperature field and soot distribution characteristics from conventional combustion methods; specifically, the temperature field is usually more uniform, the temperature gradient is smaller, and the soot distribution is more dispersed in space and presents different particle size and concentration distribution characteristics. These characteristics make the traditional single-point detection method difficult to apply. Therefore, there is currently a lack of a detection method for the entire process of soot generation under MILD combustion.

### SUMMARY

A primary objective of the present invention is to provide a soot detection method for a MILD combustion system of tar-containing biomass gasified gas, which achieves accurate supply of the tar-containing biomass gasified gas, ensures that tar participates in combustion in a gaseous state, establishes the MILD combustion of the tar-containing biomass gasified gas with oxygen-containing hot coflow formed by a diffusion plane flame in an open space, and detects the whole process of the soot from a gas-phase precursor to soot particles by combining an invasive thermophoresis sampling technology and an optical diagnosis technology of the soot particles so as to study the generation and control mechanism of the soot of the tar-containing biomass gasified gas in a MILD combustion mode.

To solve the above technical problem, the present invention adopts the following technical solution.

A soot detection method for a MILD combustion system of tar-containing biomass gasified gas includes the following steps:
S1. mounting a MILD combustion system of tar-containing biomass gasified gas;
S2. mounting a soot detection system;
S3. detecting soot generation process;
wherein the combustion system in the step S1 includes a controlled evaporator and mixer configured to supply tar-containing biomass gasified gas, a heating pipeline configured to convey the tar-containing biomass gasified gas and an oxygen-containing hot coflow-guided biomass gasified gas MILD burner formed by a diffusion plane flame in an open space, wherein the tar is evaporated into gas by the controlled evaporator and mixer and is uniformly mixed with the biomass gasified gas and is supplied to the biomass gasified gas MILD burner via the heating pipeline, and the biomass gasified gas MILD burner guided by the diffusion plane flame increases an initial temperature, reduces an ignition delay time and increases a chemical reaction time with the hot coflow to achieve MILD combustion of the biomass gasified gas;
the detection system in the step S2 includes a thermophoresis sampling system and an optical diagnosis system, the thermophoresis sampling system collects soot particles at different positions in the flame, and the optical diagnosis system semi-quantitatively measures concentrations of polycyclic aromatic hydrocarbon, hydroxyl and soot in the flame in the open space; and
soot particle sampling, soot distribution detection, polycyclic aromatic hydrocarbon distribution detection and hydroxyl distribution detection are sequentially performed in the step S3.

Further, the controlled evaporator and mixer in the step S1 includes a data control module, a liquid flow meter, a mixing evaporator and a gas flow meter, the liquid flow meter, the mixing evaporator and the gas flow meter are all electrically connected to the data control module, one end of the liquid flow meter is connected to the mixing evaporator via a pipeline, another end of the liquid flow meter is connected to a toluene bottle via a pipeline, the toluene bottle is connected to a centrifugal pump via a pipeline, one end of the gas flow meter is connected to the mixing evaporator via a pipeline, and another end of the gas flow meter is connected to a biomass gasified gas cylinder via a pipeline; and
toluene liquid in the toluene bottle is connected into the mixing evaporator via the liquid flow meter under the pressure of nitrogen, biomass gasified gas in the biomass gasified gas cylinder is connected into the mixing evaporator via the gas flow meter, then the heating pipeline is configured to connect an outlet of the mixing evaporator and a main fuel inlet of the biomass gasified gas MILD burner, and gas flow rate, liquid flow rate and evaporation temperature are regulated under the control of the data control module, so that evaporation of different types of tar and mixing between the tar and the biomass gasified gas in different proportions are achieved.

Further, the mixing evaporator includes a heating cavity and a storage cavity, the heating cavity heats and mixes and evaporates a mixture of atomized gas and liquid injected therein, and the storage cavity temporarily stores a gasified mixed gas; and
a temperature of the heating cavity is not lower than 110.6° C., so as to ensure evaporation of the toluene.

Further, a heating tape is wound around the heating pipeline, and the heating tape is tightly spirally wound, and a heating temperature of the heating pipeline is not lower than a boiling point of the evaporated liquid at a corresponding pressure, so as to ensure that the evaporated liquid is not condensed into liquid again and thus block the pipeline; and
the heating tape includes a temperature control component, an electric heating tape and a thermal insulation layer, wherein the temperature control component is configured to regulate a temperature of the electric heating tape, the electric heating tape is a nickel-chromium alloy resistance wire with an outer layer wrapped by silicon rubber, and the thermal insulation layer is made of needled glass fiber mat.

Further, in the step S1, the biomass gasified gas MILD burner is first positioned and then fixed on a test bench before installation;
the biomass gasified gas MILD burner is a two-stage combustion system with an open space, and includes tar-containing biomass gasified gas as a jet main fuel and high-temperature hot coflow, the high-temperature hot coflow is formed by lean diffusion flame of CH₄/H₂-air, oxygen-containing flue gas generated is used as an oxidant of the biomass gasified gas to form a high-temperature, low-oxygen, diluted combustion condition, so that MILD combustion is achieved, and the open space ensures good optical system access and invasive sampling operations; and
a fuel of the hot coflow is a mixed gas composed of 50% of CH₄ and 50% of H₂, and the oxidant is a mixed gas composed of O₂ and N₂.

Further, the thermophoresis sampling system in the step S2 includes a programmable time relay, an air compressor, a solenoid valve, an air cylinder, a self-locking tweezer, a TEM copper grid and a lifting table, the self-locking tweezer clamps the TEM copper grid and is connected to a tail end of the air cylinder, the air cylinder is installed on a top of the lifting table, and a position of the air cylinder is controlled by the lifting table to ensure that soot particles at different heights of flame are collected; and
the air compressor provides pneumatic power for the air cylinder, the programmable time relay controls the solenoid valve, the solenoid valve controls movement of the air cylinder, and then the TEM copper grid clamped by the self-locking tweezer enters flame to sample the soot particles.

Further, the optical diagnosis system in the step S2 includes an ICCD camera, a dual imager, a sheet optical lens group, a dye laser, a neodymium-doped yttrium aluminium garnet (Nd:YAG) laser, a timing trigger, an ICCD controller and a filter group;
the Nd:YAG laser and the sheet optical lens group cooperate with a frequency-doubling crystal group to generate second harmonic and output laser with a wavelength of 532 nm, which is used to excite incandescence signals of the soot; and
the Nd:YAG laser and the dye laser cooperate with a frequency-doubling crystal group and a laser reflector group to generate laser with two wavelengths of 266 nm and 283 nm, which are used to excite polycyclic aromatic hydrocarbon and hydroxyl radical signals.

Further, for the soot particle sampling in the step S3, a program-controlled solenoid valve is arranged on the programmable time relay to further control the air cylinder, the residence time of the TEM copper grid in the flame is strictly controlled to ensure the accuracy of sampling and subsequent analysis, and the obtained soot particles are analyzed for morphology and structure with a transmission electron microscope to obtain data on stripe spacing, stripe width and stripe curvature;
for the polycyclic aromatic hydrocarbon distribution detection, a 315 nm bandpass filter is selected to measure A1, a 400 nm bandpass filter is selected to measure A2 and A3, a 492 nm bandpass filter is selected to measure A4, the signals are captured and recorded by the ICCD camera, wherein A1 refers to benzene, A2 refers to a diphenyl ring, A3 refers to a triphenyl ring, and A4 refers to a tetraphenyl ring; and
for the hydroxyl distribution detection, the hydroxyl signal is processed by a 300-320 nm bandpass filter and then captured and recorded by the ICCD camera.

Further, for the soot distribution detection in the step S3, the incandescence signals radiated by the soot are filtered by 450 nm and 650 nm bandpass filters installed on the dual imager, then converted into LII signals by two specific wavelengths corresponding to pixel positions, and captured and recorded by the ICCD camera; the interference of the polycyclic aromatic hydrocarbon groups on the soot measurement is eliminated with a bandpass filter with a central wavelength of 440 nm, and the obtained LII signals are calculated by formulas (1) and (2) to obtain a temperature Tₚ and a volume fraction fᵥ of the soot after excitation,

$$\begin{matrix}formula ( 1 ) : & \\ \frac{{λ}_{2}^{6} E ( {m}_{λ 1} )}{{λ}_{1}^{6} E ( {m}_{λ 2} )} exp [ - \frac{hc}{{kT}_{p}} ( \frac{1}{{λ}_{1}} - \frac{1}{{λ}_{2}} ) ] = \frac{{V}_{Exp 1}}{{V}_{Exp 2}} \frac{{η}_{2}}{{η}_{1}} \frac{{G}_{Exp 2}}{{G}_{Exp 1}} & \end{matrix}$$

$$\begin{matrix}formula ( 2 ) : & \\ {f}_{V} = \frac{{V}_{E x p}}{η {w}_{b} {G}_{E x p} \frac{12 π {c}^{2} h}{{λ}^{6}} {E ( {m}_{λ} ) [ exp ( \frac{h c}{k λ {T}_{p}} ) - 1 ]}^{- 1}} & \end{matrix}$$

wherein λ_{1,2} is the central wavelength of the selected bandpass filter, h is Planck constant, c is light speed, k is Boltzmann constant, E(m_{λ}) is a soot absorption function at wavelength λ, V_{Exp} is an intensity of the signal output by ICCD, G_{Exp} is a gain of the detection system, w_{b} is a thickness of the laser sheet, and η(λ) is a ratio of the output signal to an incident light intensity.

Further, before performing the step S1, the gas flow rate of the biomass gasified gas and the liquid flow rate of the tar are calculated according to a tar content of required gasified gas. Compared with the prior art, the present invention has the following beneficial effects:

In view of the characteristics of uncertain tar content and easy condensation of tar-containing biomass gasified gas, the controlled evaporator and mixer and a plurality of modules work together to accurately control the flow rate, evaporation temperature and mixing ratio of gas and liquid, which realizes the supply of biomass gasified gas fuel with different tar contents, and ensures that tar (or model compound of the tar) participates in combustion in a liquid state;
in view of the characteristics of open space staged burners that has the advantages of convenient invasive detection operation and good optical access, the thermophoresis sampling technology and optical diagnosis technology of soot particles are combined to achieve the detection of the whole process from gas phase precursor to soot particle generation; and
in view of the characteristics of uniform flame temperature field under MILD combustion conditions, more dispersed soot distribution in space and different particle size and concentration distribution, optical diagnosis technology is selected to detect the soot distribution of the entire flame, avoiding the large errors caused by single-point sampling detection.

### BRIEF DESCRIPTION OF THE DRAWINGS

FIG. 1 is a schematic diagram of a controlled evaporator and mixer according to the present invention.

FIG. 2 is a schematic diagram of a thermophoresis sampling system according to the present invention.

FIG. 3 is a schematic diagram of an optical diagnosis system according to the present invention.

Description of the reference numerals: 1: data control module, 2: liquid flow meter, 3: centrifugal pump, 4: toluene bottle, 5: heating tape, 6: mixing evaporator, 7: biomass gasified gas cylinder, 8: gas flow meter, 9: programmable time relay, 10: air compressor, 11: solenoid valve, 12: air cylinder, 13: self-locking tweezer, 14: TEM copper grid, 15: lifting table, 16: ICCD camera, 17: dual imager, 18: biomass gasified gas MILD burner, 19: sheet optical lens group, 20: dye laser, 21: Nd:YAG laser, 22: timing controller, and 23: ICCD controller.

### DETAILED DESCRIPTION OF THE EMBODIMENTS

The technical solution of the present invention is further explained below by accompanying drawings and the embodiments.

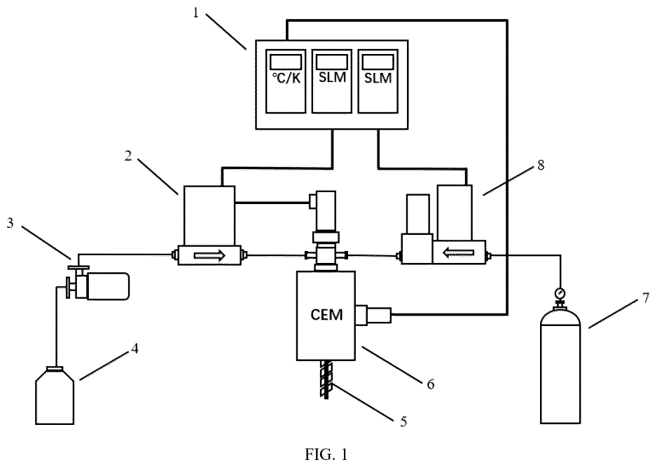

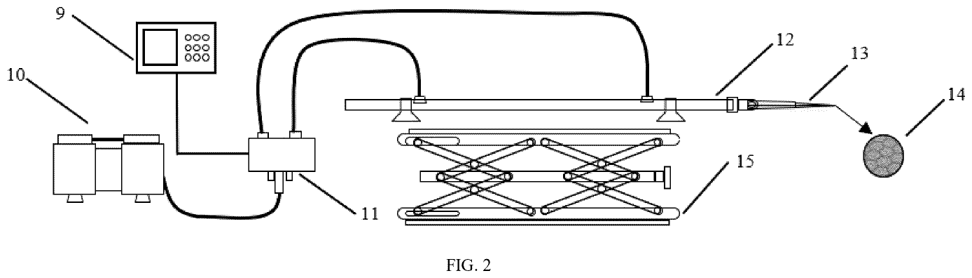

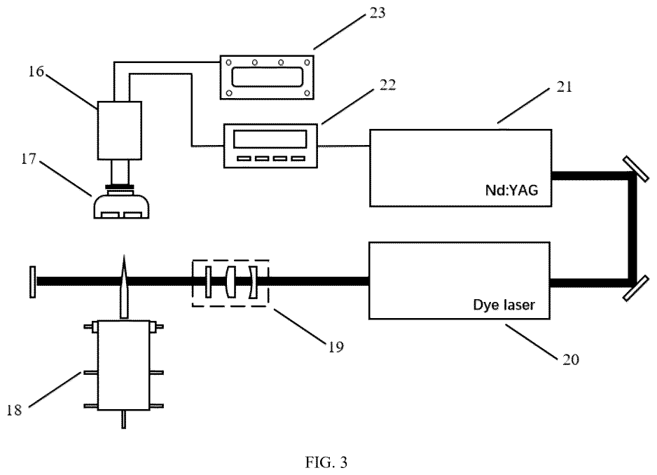

Referring to FIG. 1 to FIG. 3, an embodiment provides a soot detection method for a MILD combustion system of tar-containing biomass gasified gas, which includes the following steps:
S0. calculating a gas flow rate of biomass gasified gas and a liquid flow rate of tar according to a tar content of required gasified gas;
S1. mounting a MILD combustion system of tar-containing biomass gasified gas;
S2. mounting a soot detection system;
S3. detecting soot generation process;
wherein the combustion system in the step S1 includes a controlled evaporator and mixer configured to supply tar-containing biomass gasified gas, a heating pipeline configured to convey the tar-containing biomass gasified gas and an oxygen-containing hot coflow-guided biomass gasified gas MILD burner 18 formed by a diffusion plane flame in an open space, wherein the tar is evaporated into gas by the controlled evaporator and mixer and is uniformly mixed with the biomass gasified gas and is supplied to the biomass gasified gas MILD burner 18 via the heating pipeline, and the biomass gasified gas MILD burner 18 guided by the diffusion plane flame increases an initial temperature, reduces an ignition delay time and increases a chemical reaction time with the hot coflow to achieve MILD combustion of the biomass gasified gas;
the detection system in the step S2 includes a thermophoresis sampling system and an optical diagnosis system, the thermophoresis sampling system collects soot particles at different positions in the flame, and the optical diagnosis system semi-quantitatively measures concentrations of polycyclic aromatic hydrocarbon, hydroxyl and soot in the flame in the open space; and
soot particle sampling, soot distribution detection, polycyclic aromatic hydrocarbon distribution detection and hydroxyl distribution detection are sequentially performed in the step S3.

In this embodiment, the controlled evaporator and mixer in the step S1 includes a data control module 1, a liquid flow meter 2, a mixing evaporator 6 and a gas flow meter 8, the liquid flow meter 2, the mixing evaporator 6 and the gas flow meter 8 are all electrically connected to the data control module 1, one end of the liquid flow meter 2 is connected to the mixing evaporator 6 via a pipeline, another end of the liquid flow meter is connected to a toluene bottle 4 via a pipeline, the toluene bottle 4 is connected to a centrifugal pump 3 via a pipeline, one end of the gas flow meter 8 is connected to the mixing evaporator 6 via a pipeline, and another end of the gas flow meter is connected to a biomass gasified gas cylinder 7 via a pipeline; and
toluene liquid in the toluene bottle 4 is connected into the mixing evaporator 6 via the liquid flow meter 2 under the pressure of nitrogen, biomass gasified gas in the biomass gasified gas cylinder 7 is connected into the mixing evaporator 6 via the gas flow meter 8, then the heating pipeline is configured to connect an outlet of the mixing evaporator 6 and a main fuel inlet of the biomass gasified gas MILD burner 18, and gas flow rate, liquid flow rate and evaporation temperature are regulated under the control of the data control module 1, so that evaporation of different types of tar and mixing between the tar and the biomass gasified gas in different proportions are achieved.

Preferably, the mixing evaporator 6 includes a heating cavity and a storage cavity, the heating cavity heats and mixes and evaporates a mixture of atomized gas and liquid injected therein, and the storage cavity temporarily stores a gasified mixed gas; and a temperature of the heating cavity is not lower than 110.6° C., so as to ensure evaporation of the toluene.

Preferably, a heating tape 5 is wound around the heating pipeline, and the heating tape 5 is tightly spirally wound, and a heating temperature of the heating pipeline is not lower than a boiling point of the evaporated liquid at a corresponding pressure, so as to ensure that the evaporated liquid is not condensed into liquid again and thus block the pipeline; and the heating tape 5 includes a temperature control component, an electric heating tape and a thermal insulation layer, wherein the temperature control component is configured to regulate a temperature of the electric heating tape, the electric heating tape is a nickel-chromium alloy resistance wire with an outer layer wrapped by silicon rubber, and the thermal insulation layer is made of needled glass fiber mat.

In this embodiment, the biomass gasified gas MILD burner 18 is first positioned and then fixed on a test bench before installation in the step S1;
the biomass gasified gas MILD burner 18 is a two-stage combustion system with an open space, and includes tar-containing biomass gasified gas as a jet main fuel and high-temperature hot coflow, the high-temperature hot coflow is formed by lean diffusion flame of CH₄/H₂-air, oxygen-containing flue gas generated is used as an oxidant of the biomass gasified gas to form a high-temperature, low-oxygen, diluted combustion condition, so that MILD combustion is achieved, and the open space ensures good optical system access and invasive sampling operations; and
a fuel of the hot coflow is a mixed gas composed of 50% of CH₄ and 50% of H₂, and the oxidant is a mixed gas composed of O₂ and N₂.

In this embodiment, the thermophoresis sampling system in the step S2 includes a programmable time relay 9, an air compressor 10, a solenoid valve 11, an air cylinder 12, a self-locking tweezer 13, a TEM copper grid 14 and a lifting table 15, the self-locking tweezer 13 clamps the TEM copper grid 14 and is connected to a tail end of the air cylinder 12, the air cylinder 12 is installed on a top of the lifting table 15, and a position of the air cylinder 12 is controlled by the lifting table 15 to ensure that soot particles at different heights of flame are collected; and
the air compressor 10 provides pneumatic power for the air cylinder 12, the programmable time relay 9 controls the solenoid valve 11, the solenoid valve 11 controls movement of the air cylinder 12, and then the TEM copper grid 14 clamped by the self-locking tweezer 13 enters flame to sample the soot particles.

The optical diagnosis system in the step S2 includes an ICCD camera 16, a dual imager 17, a sheet optical lens group 19, a dye laser 20, an Nd:YAG laser 21, a timing trigger 22, an ICCD controller 23 and a filter group;
the Nd:YAG laser 21 and the sheet optical lens group 19 cooperate with a frequency-doubling crystal group to generate second harmonic and output laser with a wavelength of 532 nm, which is used to excite incandescence signals of the soot; and
the Nd:YAG laser 21 and the dye laser 20 cooperate with a frequency-doubling crystal group and a laser reflector group to generate laser with two wavelengths of 266 nm and 283 nm, which are used to excite polycyclic aromatic hydrocarbon and hydroxyl radical signals.

In this embodiment, for the soot particle sampling in the step S3, a program-controlled solenoid valve 11 is arranged on the programmable time relay 9 to further control the air cylinder 12, the residence time of the TEM copper grid 14 in the flame is strictly controlled to ensure the accuracy of sampling and subsequent analysis, and the obtained soot particles are analyzed for morphology and structure with a transmission electron microscope to obtain data on stripe spacing, stripe width and stripe curvature;
for the polycyclic aromatic hydrocarbon distribution detection, a 315 nm bandpass filter is selected to measure A1, a 400 nm bandpass filter is selected to measure A2 and A3, a 492 nm bandpass filter is selected to measure A4, the signals are captured and recorded by the ICCD camera 16, wherein A1 refers to benzene, A2 refers to a diphenyl ring, A3 refers to a triphenyl ring, and A4 refers to a tetraphenyl ring; and
for the hydroxyl distribution detection, the hydroxyl signal is processed by a 300-320 nm bandpass filter and then captured and recorded by the ICCD camera 16.

For the soot distribution detection, the incandescence signals radiated by the soot are filtered by 450 nm and 650 nm bandpass filters installed on the dual imager 17, then converted into LII signals by two specific wavelengths corresponding to pixel positions, and captured and recorded by the ICCD camera 16; the interference of the polycyclic aromatic hydrocarbon groups on the soot measurement is eliminated with a bandpass filter with a central wavelength of 440 nm, and the obtained LII signals are calculated by formulas (1) and (2) to obtain a temperature Tₚ and a volume fraction fᵥ of the soot after excitation,

$$\begin{matrix}formula ( 1 ) : & \\ \frac{{λ}_{2}^{6} E ( {m}_{λ 1} )}{{λ}_{1}^{6} E ( {m}_{λ 2} )} exp [ - \frac{hc}{{kT}_{p}} ( \frac{1}{{λ}_{1}} - \frac{1}{{λ}_{2}} ) ] = \frac{{V}_{Exp 1}}{{V}_{Exp 2}} \frac{{η}_{2}}{{η}_{1}} \frac{{G}_{Exp 2}}{{G}_{Exp 1}} & \end{matrix}$$

$$\begin{matrix}formula ( 2 ) : & \\ {f}_{V} = \frac{{V}_{E x p}}{η {w}_{b} {G}_{E x p} \frac{12 π {c}^{2} h}{{λ}^{6}} {E ( {m}_{λ} ) [ exp ( \frac{h c}{k λ {T}_{p}} ) - 1 ]}^{- 1}} & \end{matrix}$$

wherein λ_{1,2} is the central wavelength of the selected bandpass filter, h is Planck constant, c is light speed, k is Boltzmann constant, E(m_{λ}) is a soot absorption function at wavelength λ, V_{Exp} is an intensity of the signal output by ICCD, G_{Exp} is a gain of the detection system, w_{b} is a thickness of the laser sheet, and η(λ) is a ratio of the output signal to an incident light intensity.

It should also be explained that the soot generation process includes 1. formation of soot precursors (polycyclic aromatic hydrocarbons); 2. soot nucleation; 3. surface growth of particles; and 4. oxidation and fragmentation of particles. The formation of the first benzene ring is the key step in the formation of soot precursors, and A4 is the key species for soot nucleation, so these substances must be detected.

The above description is merely preferred embodiments of the present invention, and is not intended to limit the technical scope of the present invention. As such, any minor amendments, equivalent changes and modifications made to the above embodiments according to the technical spirit of the present invention shall fall within the scope of the technical solutions of the present invention.

What is claimed is:

1. A soot detection method for a moderate or intense low oxygen dilution (MILD) combustion system of a tar-containing biomass gasified gas, comprising the following steps:
S1, mounting the MILD combustion system of the tar-containing biomass gasified gas;
S2, mounting a soot detection system;
S3, detecting a soot generation process;
wherein the MILD combustion system in the step S1 comprises a controlled evaporator and mixer configured to supply the tar-containing biomass gasified gas, a heating pipeline configured to convey the tar-containing biomass gasified gas, and an oxygen-containing hot coflow-guided biomass gasified gas MILD burner formed by a diffusion plane flame in an open space, wherein a tar is evaporated into a gas by the controlled evaporator and mixer and is uniformly mixed with a biomass gasified gas, and is supplied to the oxygen-containing hot coflow-guided biomass gasified gas MILD burner via the heating pipeline, and the oxygen-containing hot coflow-guided biomass gasified gas MILD burner guided by the diffusion plane flame increases an initial temperature, reduces an ignition delay time, and increases a chemical reaction time with a hot coflow to achieve an MILD combustion of the tar-containing biomass gasified gas;
the soot detection system in the step S2 comprises a thermophoresis sampling system and an optical diagnosis system, the thermophoresis sampling system collects soot particles at different positions in a flame, and the optical diagnosis system semi-quantitatively measures concentrations of a polycyclic aromatic hydrocarbon, hydroxyl, and a soot in the flame in the open space; and
a soot particle sampling, a soot distribution detection, a polycyclic aromatic hydrocarbon distribution detection, and a hydroxyl distribution detection are sequentially performed in the step S3.

2. The soot detection method for the MILD combustion system of the tar-containing biomass gasified gas according to claim 1, wherein the controlled evaporator and mixer in the step S1 comprises a data control module, a liquid flow meter, a mixing evaporator, and a gas flow meter, the liquid flow meter, the mixing evaporator, and the gas flow meter are all electrically connected to the data control module, a first end of the liquid flow meter is connected to the mixing evaporator via a first pipeline, a second end of the liquid flow meter is connected to a toluene bottle via a second pipeline, the toluene bottle is connected to a centrifugal pump via a third pipeline, a first end of the gas flow meter is connected to the mixing evaporator via a fourth pipeline, and a second end of the gas flow meter is connected to a biomass gasified gas cylinder via a fifth pipeline; and
a toluene liquid in the toluene bottle is connected into the mixing evaporator via the liquid flow meter under a pressure of nitrogen, the biomass gasified gas in the biomass gasified gas cylinder is connected into the mixing evaporator via the gas flow meter, then the heating pipeline is configured to connect an outlet of the mixing evaporator and a main fuel inlet of the oxygen-containing hot coflow-guided biomass gasified gas MILD burner, and a gas flow rate, a liquid flow rate, and an evaporation temperature are regulated under a control of the data control module, so that an evaporation of different types of the tar and a mixing between the tar and the biomass gasified gas in different proportions are achieved.

3. The soot detection method for the MILD combustion system of the tar-containing biomass gasified gas according to claim 2, wherein the mixing evaporator comprises a heating cavity and a storage cavity, the heating cavity heats and mixes and evaporates a mixture of an atomized gas and a liquid to obtain a gasified mixed gas, wherein the atomized gas and the liquid are injected in the heating cavity, and the storage cavity temporarily stores the gasified mixed gas; and
a temperature of the heating cavity is greater than or equal to 110.6° C. to ensure an evaporation of the toluene liquid.

4. The soot detection method for the MILD combustion system of the tar-containing biomass gasified gas according to claim 2, wherein a heating tape is wound around the heating pipeline, the heating tape is tightly spirally wound, and a heating temperature of the heating pipeline is greater than or equal to a boiling point of an evaporated liquid at a corresponding pressure to ensure that the evaporated liquid is not condensed into a liquid again and thus block the heating pipeline; and
the heating tape comprises a temperature control component, an electric heating tape, and a thermal insulation layer, wherein the temperature control component is configured to regulate a temperature of the electric heating tape, the electric heating tape is a nickel-chromium alloy resistance wire with an outer layer wrapped by silicon rubber, and the thermal insulation layer is made of needled glass fiber mat.

5. The soot detection method for the MILD combustion system of the tar-containing biomass gasified gas according to claim 1, wherein in the step S1, the oxygen-containing hot coflow-guided biomass gasified gas MILD burner is first positioned and then fixed on a test bench before an installation;
the oxygen-containing hot coflow-guided biomass gasified gas MILD burner is a two-stage combustion system with the open space, and comprises the tar-containing biomass gasified gas as a jet main fuel and a high-temperature hot coflow, the high-temperature hot coflow is formed by a lean diffusion flame of CH₄/H₂-air, an oxygen-containing flue gas generated is regarded as an oxidant of the biomass gasified gas to form a high-temperature, low-oxygen, diluted combustion condition, so that the MILD combustion is achieved, and the open space ensures a good optical system access and invasive sampling operations; and
a fuel of the hot coflow is a mixed gas comprising 50% of CH₄ and 50% of H₂, and the oxidant is a mixed gas comprising O₂ and N₂.

6. The soot detection method for the MILD combustion system of the tar-containing biomass gasified gas according to claim 1, wherein the thermophoresis sampling system in the step S2 comprises a programmable time relay, an air compressor, a solenoid valve, an air cylinder, a self-locking tweezer, a transmission electron microscopy (TEM) copper grid, and a lifting table, the self-locking tweezer clamps the TEM copper grid and is connected to a tail end of the air cylinder, the air cylinder is installed on a top of the lifting table, and a position of the air cylinder is controlled by the lifting table to ensure that the soot particles at different heights of the diffusion plane flame are collected; and
the air compressor provides a pneumatic power for the air cylinder, the programmable time relay controls the solenoid valve, the solenoid valve controls a movement of the air cylinder, and then the TEM copper grid clamped by the self-locking tweezer enters the diffusion plane flame to sample the soot particles.

7. The soot detection method for the MILD combustion system of the tar-containing biomass gasified gas according to claim 6, wherein the optical diagnosis system in the step S2 comprises an intensified charge-coupled device (ICCD) camera, a dual imager, a sheet optical lens group, a dye laser, a neodymium-doped yttrium aluminium garnet (Nd:YAG) laser, a timing trigger, an ICCD controller, and a filter group;
the Nd:YAG laser and the sheet optical lens group cooperate with a frequency-doubling crystal group to generate a second harmonic and output a laser with a wavelength of 532 nm, wherein the laser with the wavelength of 532 nm is configured to excite incandescence signals of the soot; and
the Nd:YAG laser and the dye laser cooperate with the frequency-doubling crystal group and a laser reflector group to generate a laser with a wavelength of 266 nm and a laser with a wavelength of 283 nm, wherein the laser with the wavelength of 266 nm and the laser with the wavelength of 283 nm are configured to excite polycyclic aromatic hydrocarbon signals and hydroxyl radical signals.

8. The soot detection method for the MILD combustion system of the tar-containing biomass gasified gas according to claim 7, wherein for the soot particles sampling in the step S3, a program-controlled solenoid valve is arranged on the programmable time relay to further control the air cylinder, a residence time of the TEM copper grid in the diffusion plane flame is strictly controlled to ensure an accuracy of sampling and subsequent analysis, and the soot particles are analyzed for a morphology and a structure with a transmission electron microscope to obtain data on a stripe spacing, a stripe width, and a stripe curvature;
for the polycyclic aromatic hydrocarbon distribution detection, a 315 nm bandpass filter is selected to measure A1, a 400 nm bandpass filter is selected to measure A2 and A3, a 492 nm bandpass filter is selected to measure A4, signals are captured and recorded by the ICCD camera, wherein A1 refers to benzene, A2 refers to a diphenyl ring, A3 refers to a triphenyl ring, and A4 refers to a tetraphenyl ring; and
for the hydroxyl distribution detection, a hydroxyl signal is processed by a 300-320 nm bandpass filter and then captured and recorded by the ICCD camera.

9. The soot detection method for the MILD combustion system of the tar-containing biomass gasified gas according to claim 7, wherein for the soot distribution detection in the step S3, the incandescence signals radiated by the soot are filtered by 450 nm and 650 nm bandpass filters installed on the dual imager, then converted into LII signals by two wavelengths corresponding to pixel positions, and captured and recorded by the ICCD camera; an interference of polycyclic aromatic hydrocarbon groups on a soot measurement is eliminated with a bandpass filter with a central wavelength of 440 nm, and the LII signals are calculated by formulas (1) and (2) to obtain a temperature Tₚ and a volume fraction fᵥ of the soot after an excitation,
$$\frac{{λ}_{2}^{6} E ( {m}_{λ 1} )}{{λ}_{1}^{6} E ( {m}_{λ 2} )} exp [ - \frac{hc}{{kT}_{p}} ( \frac{1}{{λ}_{1}} - \frac{1}{{λ}_{2}} ) ] = \frac{{V}_{Exp 1}}{{V}_{Exp 2}} \frac{{η}_{2}}{{η}_{1}} \frac{{G}_{Exp 2}}{{G}_{Exp 1}} \qquad formula ( 1 )$$
$${f}_{V} = \frac{{V}_{E x p}}{η {w}_{b} {G}_{E x p} \frac{12 π {c}^{2} h}{{λ}^{6}} {E ( {m}_{λ} ) [ exp ( \frac{h c}{k λ {T}_{p}} ) - 1 ]}^{- 1}} \qquad formula ( 2 )$$
wherein λ_{1,2} is the central wavelength of the bandpass filter, h is Planck constant, c is light speed, k is Boltzmann constant, E(m_{λ}) is a soot absorption function at a wavelength λ, V_{Exp} is an intensity of a signal output by ICCD, G_{Exp} is a gain of a detection system, w_{b} is a thickness of a laser sheet, and η(λ) is a ratio of an output signal to an incident light intensity.

10. The soot detection method for the MILD combustion system of the tar-containing biomass gasified gas according to claim 1, wherein before performing the step S1, a gas flow rate of the biomass gasified gas and a liquid flow rate of the tar are calculated according to a tar content of a required gasified gas.
